(19) United States
(12) Patent Application Publication
(10) Pub. No.: US 2026/0178421 A1
(43) Pub. Date: Jun. 25, 2026

(54) SYSTEMS AND METHODS FOR DEADLOCK MITIGATION

(71) Applicant: UNTETHER AI CORPORATION, Toronto (CA)

(72) Inventors: Matt AGOSTINI, Brampton (CA); Scott ROSTRUP, Toronto (CA)

(21) Appl. No.: 19/426,410

(22) Filed: Dec. 19, 2025

Related U.S. Application Data
(60) Provisional application No. 63/737,011, filed on Dec. 20, 2024.

(51) Int. Cl. G06F 9/52

(52) U.S. Cl. CPC G06F 9/524

(57) ABSTRACT

A method includes generating configuration data for a computing apparatus having a plurality of processing units with associated memory. The configuration data defines (i) a plurality of nodes corresponding to the processing units, and (ii) a plurality of buffers connecting respective pairs of the nodes, each buffer having a storage capacity. The method further includes executing a dataflow simulation using the configuration data, and in response to detecting a deadlock in the simulation, determining a candidate buffer associated with the deadlock. The method includes updating the configuration data to increase a storage capacity of the candidate buffer, and deploying the updated configuration data to the computing apparatus.

### CROSS-REFERENCE TO RELATED APPLICATION

This application claims priority to U.S. Provisional Patent Application No. 63/737,011, filed Dec. 20, 2024, the contents of which is incorporated herein by reference.

### FIELD

The specification relates generally to dataflow computational architectures, and specifically to systems and methods for mitigating deadlock conditions in such architectures.

### BACKGROUND

A compiler for an inference computing apparatus, such as a coprocessor or other accelerator hardware, may take as input a neural network definition, e.g., in the form of a directed acyclic graph (DAG). The compiler may produce configuration data and/or a sequence of instructions for deployment to the inference computing apparatus. The configuration data may define interconnections between processing units of the computing apparatus. Under some conditions, the configuration data may lead to a deadlock, in which the computing apparatus is unable to complete the instruction sequence due to interdependent resource constraints among the processing units.

### SUMMARY

Examples disclosed herein are directed to a method including: generating configuration data for a computing apparatus having a plurality of processing units with associated memory, the configuration data defining (i) a plurality of nodes corresponding to the processing units, and (ii) a plurality of buffers connecting respective pairs of the nodes, each buffer having a storage capacity; executing a dataflow simulation using the configuration data; in response to detecting a deadlock in the simulation, determining a candidate buffer among the buffers, the candidate buffer associated with the deadlock; updating the configuration data to increase a storage capacity of the candidate buffer; and deploying the updated configuration data to the computing apparatus.

Additional examples disclosed herein are directed to a computing device, including: an interface connected with a computing apparatus having a plurality of processing units with associated memory; and a processor configured to: generate configuration data for the computing apparatus, the configuration data defining (i) a plurality of nodes corresponding to the processing units, and (ii) a plurality of buffers connecting respective pairs of the nodes, each buffer having a storage capacity; execute a dataflow simulation using the configuration data; in response to detecting a deadlock in the simulation, determine a candidate buffer among the buffers, the candidate buffer associated with the deadlock; update the configuration data to increase a storage capacity of the candidate buffer; and deploy the updated configuration data to the computing apparatus via the interface.

### BRIEF DESCRIPTIONS OF THE DRAWINGS

Embodiments are described with reference to the following figures.

FIG. 1 is a diagram of a system for compiling a computation graph for deployment to an inference computing apparatus.

FIG. 2 is a diagram of the inference computing apparatus of FIG. 1.

FIGS. 3A-3G are diagrams illustrating a sequence of states leading to a deadlock at the computing apparatus of FIG. 1.

FIG. 4 is a flowchart of a method for deadlock mitigation.

FIG. 5 is a flowchart of a method for determining candidate buffers in the method of FIG. 4.

FIG. 6 is a diagram illustrating an example performance of the method of FIG. 5.

FIG. 7 is a diagram illustrating another set of example configuration data.

### DETAILED DESCRIPTION

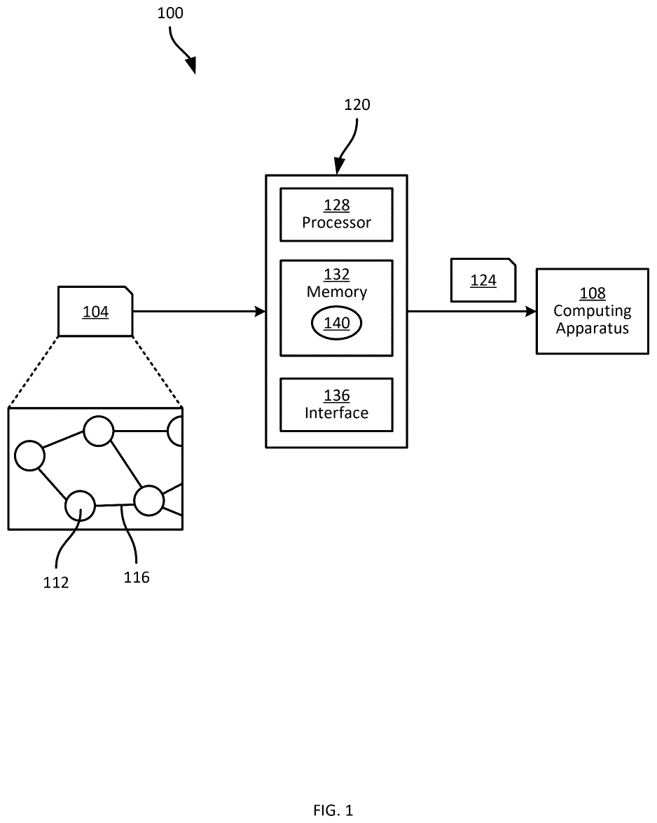

FIG. 1 illustrates a system 100 for compiling a computation graph 104 for execution by a computing apparatus 108. The computing apparatus 108 can be, for example, implemented in the form of an integrated circuit (e.g., a chip) deployed as a component of a coprocessor board configured to perform certain operations in a computing device such as a desktop computer, a server, or the like. The apparatus 108 can therefore include one or more integrated circuit components implementing command-execution circuitry, storage elements, and the like. In other examples, the apparatus 108 can be deployed as a primary processor (e.g., a central processing unit).

The computing apparatus 108 can be configured, for example, to execute instructions implementing inference functionality, e.g., implementing neural networks such as large language models (LLMs), machine vision inference engines, or other suitable artificial intelligence-based applications. The computation graph 104 can be received as input, e.g., from another software routine or the like, e.g., in the form of a directed acyclic graph (DAG) defining a plurality of nodes 112 connected by edges 116. Various other forms of data structures can be used to define the graph 104. The system 100 includes a compiling computing device 120 configured to receive the graph 104, and perform various functions to convert the graph 104 into configuration data 124 deployable to the computing apparatus 108. The generation of configuration data can include any of a wide variety of compiling strategies implemented at the device 120. The configuration data 124, in other words, is a compiled version of the graph 104, specific to the hardware elements of the computing apparatus 108.

As will be apparent, the device 120 can be a host computing device for which the apparatus 108 is a coprocessor, e.g., an accelerator card or the like. The device 120 includes a processor 128, e.g., one or more central processing units (CPU) or the like, and a memory 132 (e.g., any suitable combination of volatile and/or non-volatile memory components). The device 120 also includes an interface 136, e.g., a peripheral component interconnect (PCI) bus or other suitable data interface connecting the processor 128 and/or memory 132 with the apparatus 108.

The memory 132 can store a plurality of computer readable instructions, executable by the processor 128 to perform functionality related to the generation of configuration data 124 based on the graph 104. The memory 132 can store, for example, a compiler application 140 whose execution by the processor 128 configures the processor 128 to process the graph 104, executing any suitable combination of compiler strategies to generate the configuration data 124. In some examples, the functionality implemented via execution of the application 140 can be implemented in dedicated hardware element(s), such as an application-specific integrated circuit or the like.

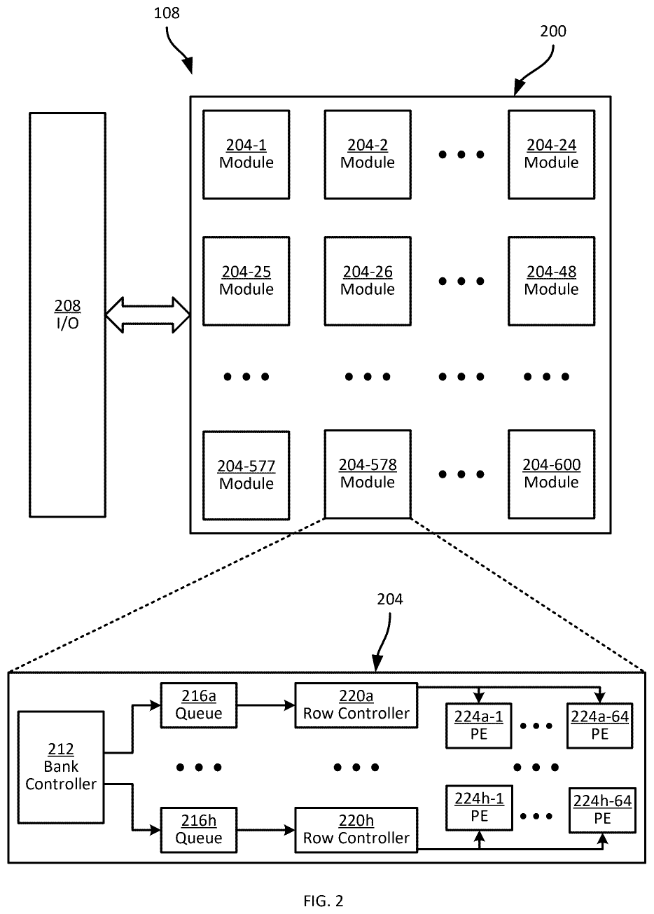

Turning briefly to FIG. 2, certain example components of the apparatus 108 are illustrated. The apparatus 108 includes an array 200 of computing modules 204, which can also be referred to as banks 204 and are illustrated with hyphenated suffixes in FIG. 2 to distinguish between individual modules 204. That is, each module 204 can be referred to with a corresponding suffix, such as the modules 204-1, 204-2, 204-24, 204-25, 204-26, 204-48, 204-577, 204-578, and 204-600 shown in FIG. 1. The modules 204 are referred to collectively or generically by omitting the suffix. The array 200 can include a wide variety of numbers of modules 204, e.g., depending on performance and/or cost constraints for the apparatus 108. In the illustrated example, the array 200 includes a total of six hundred modules 204, arranged in twenty-five rows of twenty-four modules 204 each. This arrangement is purely illustrative, and both the number of modules 204 and their physical arrangement in the array 200 can vary in other implementations.

Each module 204 includes various subcomponents for performing computations such as single-instruction, multiple data (SIMD) operations such as sets of multiply-accumulate operations. Example components of the modules 204 will be described below. The modules 204 can be interconnected with one another and/or with shared storage elements, e.g., via one or more communication buses (not shown). In addition, the array 200 is connected with one or more input/output modules 208, e.g., via one or more communication buses, for communicating with other computing apparatuses, other components of the above-mentioned coprocessor board, or the like. In some examples, the apparatus 108 can include more than one I/O module 208.

Example components of a module 204 are also shown in FIG. 1. Each module 204 includes a controller, also referred to as a bank controller 212. The bank controller 212 includes various internal components, such as cache memory, state information registers, I/O components, and the like. The bank controller 212 is configured to execute machine-readable programming instructions, e.g., retrieved from the above-mentioned cache and/or a memory element external to the bank controller 212. According to the execution of such instructions, the bank controller 212 is configured to generate commands defining operations (e.g., multiply-accumulate operations) to be performed within the module 204.

The module 204 also includes a plurality of additional processing components, e.g., arranged in linear arrays (e.g., rows), with each array connected with the bank controller 212. As shown in FIG. 1, the module 204 can include eight such rows, although in other embodiments the module 204 can include more or fewer rows than eight. Each row includes a queue 216 (thus, for example, the module 204 includes eight queues 216a through 216h), and a row controller 220 (in this example, the module 204 thus includes eight row controllers 220a through 220h). The bank controller 212 is configured to place the commands mentioned above into the queues 216 according to any suitable row-selection logic implemented within the bank controller 212. Each row controller 220 is configured to retrieve a command from the corresponding queue 216 (e.g., the row controller 220a retrieves commands from the queue 216a), and deploy the retrieved command to an array of processing elements (PEs) 224. In this example, each row includes sixty-four PEs 224 (e.g., PEs 224a-1 through 224a-64 correspond to the row controller 220a, and PEs 224h-1 through 224h-64 correspond to the row controller 220h).

The PEs 224 in a given row are configured to execute a single, common command at a time, but each PE 224 can execute the command using different input data from the other PEs 224. Each PE 224 can include working memory and logical circuit(s) suitable for performing a range of operations, including at least multiply-accumulate operations as mentioned above. When the PEs 224 of a given row have completed execution of an operation, the results of the operation can be returned to the corresponding row controller 220, passed to PEs 224 of an adjacent row, or the like. The array 200 can also include working memory allocatable to each PE 224. For example, each PE 224 can include dedicated memory, and/or the apparatus 108 can include memory that can be dynamically allocated between the rows of PEs 224.

The configuration data 124 can define a plurality of nodes, each corresponding to a row of PEs 224, and a plurality of edges corresponding to first-in-first-out (FIFO) buffers connecting the nodes. The configuration data can also include a variety of other parameters, e.g., defining what operations the PEs 224 represented by the above-mentioned nodes perform, and in what order. The buffers defined by the configuration data 124 can be used to store data generated by the PEs 224, e.g., before consumption by a downstream PE 224 to generate further data (which may then be output into another buffer).

The specific strategies implemented via execution of the compiler application 140 to generate the configuration data 124 from the graph 104 are outside the scope of the present discussion. However, the application 140 is also configured to assess the configuration data 124 to detect potential deadlock conditions prior to deployment of the configuration data 124 to the apparatus 108. The application 140 is further configured to update the configuration data 124 prior to deployment to the device 108, to mitigate (e.g., to entirely avoid, in some examples) deadlocks.

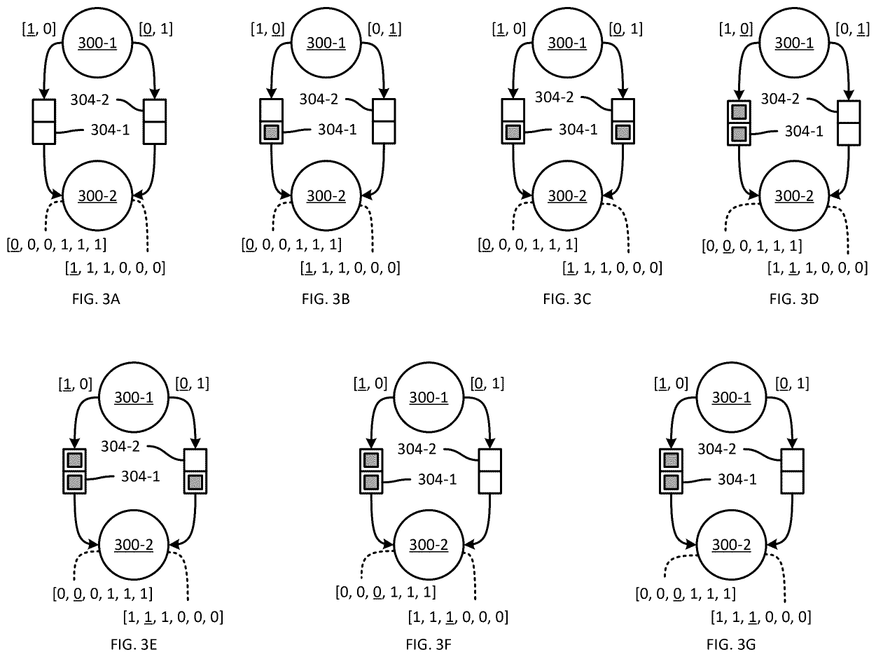

FIGS. 3A-3G illustrate an example deadlock situation, illustrated with a simplified cyclo-static dataflow (CSDF) graph representation of two nodes 300-1 and 300-2 (also referred to as actors), corresponding to respective PEs 224. The nodes 300 are connected by two edges 304-1 and 304-2, corresponding to respective buffers defined in memory element(s) of the apparatus 108. As will be apparent, the apparatus 108 may include many more than two PEs 224 and two buffers (e.g., the apparatus 108 may contain thousands of PEs 224), and the comparatively small-scale arrangement of FIGS. 3A-3G is solely for the purpose of illustration.

The CSDF graph representing the simplified apparatus 108 in FIGS. 3A-3G also includes phase data for each node. More specifically, each node 300 includes phase data corresponding to each edge connecting that node 300 to another node 300. Thus, each of the nodes 300 in FIGS. 3A-3G includes two sets of phase data, as each node 300 has two incident edges. The phase data defines, for a given node 300, an operational cycle including one or more phases, which the node 300 cycles through. The node 300-1, for example, has a two-phase operational cycle. In a first phase, the node 300-1 writes data to the buffer represented by the edge 304-1, and writes nothing to the buffer represented by the edge 304-2. In a second phase, the node 300-1 writes data to the edge 304-2, and writes nothing to the edge 304-1. The node 300-1 cycles through the above two phases, in that order.

The node 300-2, in the illustrated example, has a six-phase operational cycle. For the first three phases, the node 300-2 reads data from the edge 304-2 and nothing from the edge 304-1. For the next three phases, the node 300-2 reads data from the edge 304-1, and nothing from the edge 304-2. The nodes 300 need not synchronize their phases. That is, the node 300-1 can perform any number of operational cycles over the course of a single operational cycle at the node 300-2. Further, the phase data satisfies a consistency condition: if all the phases of the nodes 300 are expanded to the least-common-multiple (LCM), by repeating the phase cycles (e.g., 6 phases in the illustrated example), the total volume of data produced on each edge 304 must equal the total volume of data consumed on each edge 304.

Each edge 304 is defined by an initial node 300 and final node 300 (that is, the edges 304 are directional), and by a storage capacity. The initial and final nodes 300, and thus the directions, of the edges 304 in FIGS. 3A-3G are illustrated by arrows. In this example, the edges 304 both have capacities of two packets of data. The size of a packet is not particularly limited, and in some examples a node 300 can read or write more than one packet to an edge 304 (in which case the phase data for that node 300 may indicate a number greater than one for a given phase).

As will be apparent to those skilled in the art, a CSDF graph can include other information, such as a length, in cycles, of each phase for each node 300. Such information is omitted for simplicity of illustration, and because deadlock conditions of the type mitigated by the functionality described herein are latency-independent.

FIGS. 3A-3G illustrate the nodes 300 in successive states, with the phases of each node 300 to be executed highlighted with underlines. In FIG. 3A, e.g., when operation of the apparatus 108 begins, the nodes 300-1 and 300-2 are both scheduled to execute their first phases. Turning to FIG. 3B, the node 300-1 has executed its first phase, writing data to the edge 304-1 (shown via a dark square in one of the storage spaces of the edge 304-1). The node 300-1 is therefore scheduled to execute its second phase next. The node 300-2, meanwhile, has not yet executed its first phase, because the edge 304-2 contains no data.

In FIG. 3C, the node 300-1 executes its second phase, writing data to the edge 304-2. The node 300-2 does not yet execute its first phase, as such execution cannot occur until after the execution of the second phase by the node 300-1. In FIG. 3D, the node 300-1 executes its first phase again, writing data to the edge 304-1. The edge 304-1 is therefore at capacity, and cannot accept further data until data is read from the edge 304-1 by the node 300-2. The node 300-2 has also, as shown in FIG. 3D, executed its first phase, reading data from the edge 304-2 (which is therefore empty).

At FIG. 3E, the node 300-1 executes the second phase, writing data to the edge 304-2. The node 300-2 does not execute its second phase, because until the most recent writing of data to the edge 304-2 by the node 300-2, the edge 304-2 was empty. At FIG. 3F, the node 300-1 is blocked, because the next phase to be executed involves writing data to the edge 304-1, which is full. The node 300-2 executes its second phase, reading data from the edge 304-2 (which is again empty).

Finally, as shown in FIG. 3G, the node 300-1 still cannot execute its first phase, because the edge 304-1 remains full. The node 300-1 is blocked, in other words. The node 300-2 is also blocked from executing its third phase, because the edge 304-2 is empty. As a result, the node 300-2 cannot advance to its fourth phase, in which it would read data from the edge 304-1 and release capacity on the edge 304-1 for the node 300-1 to continue writing. The node 300-1 therefore remains blocked as well. The nodes 300-1 and 300-2 are therefore deadlocked. The apparatus 108, in this configuration, will fail to produce a result.

As will be apparent to those skilled in the art, the deadlock illustrated in FIGS. 3A-3G may be avoided by increasing the capacity of the edge 304-1. That is, increasing the amount of memory allocated to a buffer at the apparatus 108 that corresponds to the edge 304-1 may avoid the deadlock. For example, increasing the storage capacity of the edge 304-1 from two to three units of data enables the node 300-1 to write to the edge 304-1, completing another iteration of its first phase. The node 300-1 can then perform its second phase, writing to the edge 304-2. Because the edge 304-2 then contains data, the node 300-2 can perform its third phase (on which the node 300-2 had been blocked at FIGS. 3F and 3G), reading data from the edge 304-2. The node 300-2 can further advance to its fourth stage, and begin reading data from the edge 304-1. The node 300-1 will therefore no longer be blocked at its first phase.

While increasing buffer capacity may resolve certain deadlock conditions, identifying which buffer(s) to target for additional capacity allocations in the configuration data 124 may be difficult when the graph 104 (and therefore the configuration data 124) includes thousands or tens of thousands of nodes. Provisioning additional capacity for all buffers at such a scale is prohibitively costly.

As discussed below, the device 120, e.g., via execution of the application 140, is configured to detect deadlocks and identify specific buffers for capacity adjustments prior to deploying the configuration data 124 to the apparatus 108. The functionality implemented by the device 120 thus mitigates deadlocks in the apparatus 108 at relatively low cost (in at least some examples, at the minimum cost) in terms of memory allocations. This functionality may therefore improve resource utilization (in at least some examples, maximizing utilization) at the apparatus 108.

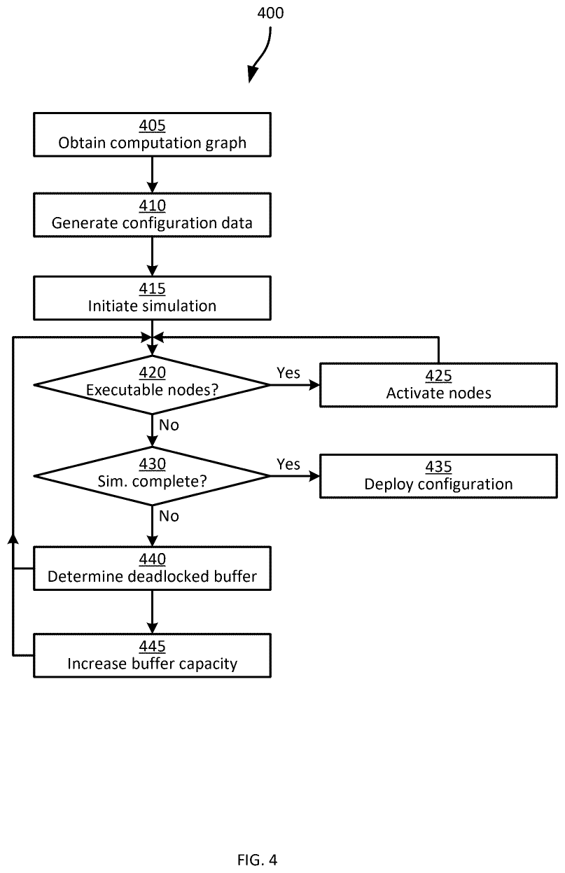

Turning to FIG. 4, a method 400 of deadlock mitigation is illustrated. The method 400 will be described below in conjunction with its performance by the device 120, e.g., via execution of the application 140 by the processor 128.

At block 405, the device 120 is configured to obtain a computation graph, e.g., the graph 104 in any suitable notation. At block 410, the device 120 is configured to generate configuration data 124. As noted above, the generation of configuration data can include the implementation of any of a variety of compilation strategies to map the graph 104 to the specific hardware components of the apparatus 108, and in particular to the PEs 224 and associated buffers. As will be seen below, the configuration data 124 generated at block 405 is not necessarily the configuration data deployed to the apparatus 108, as the configuration data 124 may be modified via the performance of the method 400 to mitigate deadlocks. The configuration data 124 can be generated in the form of a CSDF graph, though various other formats can also be employed. The configuration data 124 can include information such as types of operations to be performed by the PEs 224, volumes of data to be consumed and/or produced, cycle counts for such operations, and the like. For the purpose of deadlock detection as discussed herein, however, node and edge definitions, as well as phase data such as that shown in FIGS. 3A-3G, are considered, The remaining contents of the configuration data 124 is omitted for simplicity.

At block 415, the device 120 is configured to initiate a simulation of the apparatus 108, based on the configuration data 124 from block 410. The simulation need not involve the processing of actual input data. For example, the graph 104 may define a neural network intended for use in a machine vision application. Input data to be processed by the apparatus 108 to implement the graph 104 may be, for example, an image, or a sequence of images defining a video stream. The data provided to each PE 224 can include patches of such images, arrays derived from such patches, and the like. Each PE 224 can further be configured to perform any of a wide variety of operations on the data consumed by that PE 224. Such operations may also vary widely in complexity. The simulation initiated at block 415, however, need not perform such operations, or consume “real” input data, e.g., in the form of one or more images in the example above. Instead, the simulation initiated at block 415 can include consuming and/or generating packets of “dummy” data (e.g., strings of ones or zeroes, or the like, or in some examples simply the integer value “1” to represent a packet) in quantities according to the phase data, without performing any operations on such data. The input data to the simulation can be a synthetic image frame, e.g., consisting entirely of gray pixels. A given simulated node 300, for example, such as the node 300-1, may output a predetermined string of predefined size at its first phase, rather than generating that string based on an internal computation.

To perform the simulation, the device 120 initializes the nodes 300 and edges 304 of the configuration data 124 from block 410, e.g., as data objects accessible to the processor 128. The device 120 then, at block 420, determines whether any nodes 300 can be activated or fired. A node 300 Is executable (or fireable) if that node 300 has data available at its inputs, and is not blocked, e.g., by a full edge 304, at its outputs.

When the determination at block 420 is affirmative, the device 120 proceeds to block 425 and activates (or fires) any executable nodes. Activating the nodes 300 can include updating the data objects noted above corresponding to the edges 304, e.g., to track the current contents and/or remaining capacity of the edges 304. Activating the nodes 300 can also include updating the current phase data for the nodes 300, e.g., to indicate which phase each node 300 is expected to fire next. Following activation of one or more nodes 300 at block 425, the device 120 returns to block 420 to determine whether any further nodes 300 are executable. As will be apparent, the scenario described in conjunction with FIGS. 3A-3G illustrates a simulation in which blocks 420 and 425 are performed repeatedly through FIGS. 3A-3F.

When the determination at block 420 is negative, indicating that no nodes 300 can be fired, the device 120 proceeds to block 430. As will be apparent, a lack of executable nodes 300 may indicate a deadlock, but may also indicate that the simulation is complete, e.g., one set of synthetic input data (e.g., the synthetic image frame mentioned above) has been processed. At block 430, the device 120 is configured to determine whether the simulation is complete. The simulation can be considered complete, for example, when the nodes 300-1 and 300-2 have completed all their phases following an LCM expansion, e.g., when the node 300-1 has completed three cycles and the node 300-2 has completed one cycle. When the determination at block 430 is affirmative, the device 120 can proceed to block 435. At block 435, the configuration data 124 can be deployed to the apparatus 108, e.g., via the interface 136.

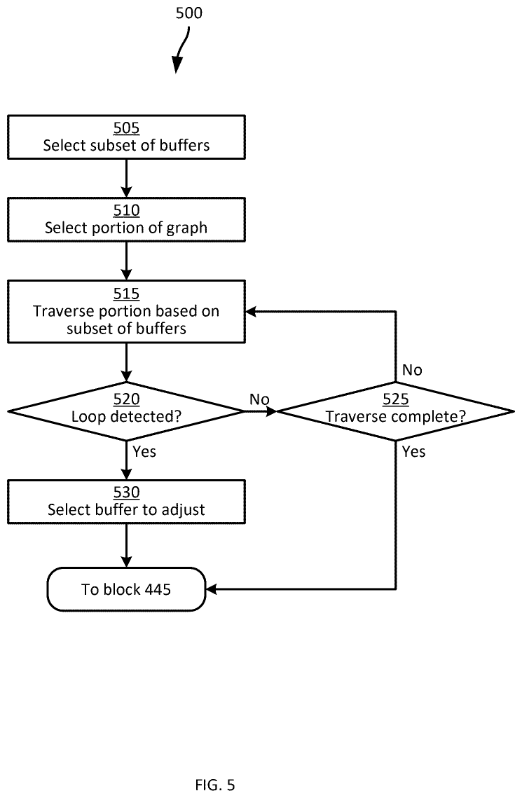

When the determination at block 430 is negative, the device 120 proceeds to block 440. Negative determinations at both blocks 420 and 430 indicate a deadlock, and at block 440, the device 120 is configured to detect one or more deadlocks in the simulation. More specifically, at block 440 the device 120 is configured to identify one or more buffers (e.g., one or more edges 304) that are associated with the deadlock. The edge(s) 304 determined at block 440 are also referred to as candidate edges or candidate buffers, as they are candidates for capacity adjustments to resolve the deadlock. The determination of candidate buffers at block 440 will be described in greater detail below in conjunction with FIG. 5. In response to determining at least one candidate buffer at block 440, at block 445 the device 120 is configured to increase the capacity of the candidate buffer(s), e.g., by a predetermined amount. That is, the data object defining a candidate buffer is updated to reflect a greater capacity.

The device 120 then returns to block 420, to determine whether any nodes 300 are fireable following the capacity adjustment from block 445. In other words, the device 120 proceeds with the simulation following the capacity adjustment at block 445. As will be apparent, the simulation may detect further deadlocks, and thus blocks 440 and 445 may be performed more than once. When the configuration data 124 is deployed at block 435, therefore, the configuration data 124 may have been updated multiple times. Further, some updates may affect different buffers, while other updates may affect a buffer whose capacity was also updated in a previous performance of block 445. That is, resolving one or more deadlocks may include increasing the capacity of a given buffer more than once.

Turning to FIG. 5, a method 500 of determining candidate buffers at block 440 of the method 400 is illustrated. The method 500 will be described below in conjunction with its performance by the device 120, e.g., via execution of the application 140 by the processor 128.

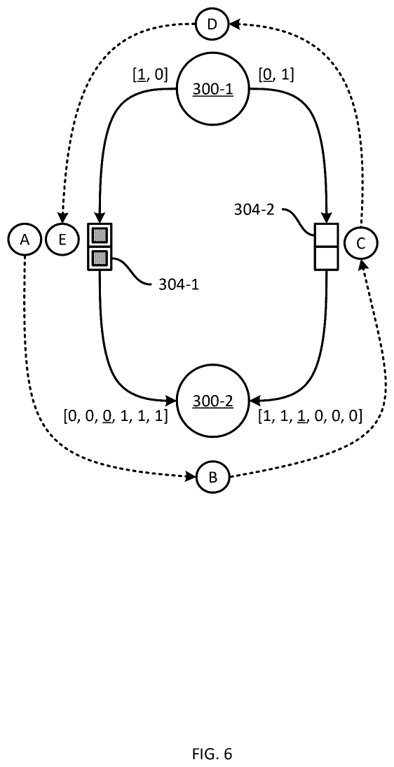

At block 505, the device 120 is configured to select a subset of edges 304 that may have contributed to the deadlock detected via the negative determinations at blocks 420 and 430. The device 120 can be configured to select edges 304 at block 505 that satisfy a predetermined set of selection criteria. A first example selection criterion is that an edge 304 under assessment is at capacity. Thus, in the example shown in FIG. 3G, which is reproduced in isolation in FIG. 6, the edge 304-1 satisfies the first criterion, while the edge 304-2 does not.

A second example selection criterion is that the edge 304 is blocking an upstream node 300-1 from sending output data to that edge 304. As seen in FIG. 6, the active phase of the node 300-1 involves writing to the edge 304-1, and the edge 304-1 is therefore blocking the node 300-1. A third example selection criterion is that the destination of the edge 304 is a node 300 with two or more inputs (that is, with two or more inbound edges 304). Referring again to FIG. 6, the edge 304-1 satisfies the third criterion because the node 300-2 has two inputs. A fourth example selection criterion is that the destination of the edge 304 is not itself blocked by a further, downstream edge 304. In the example shown in FIG. 6, the node 300-2 has no downstream edges 304 (that is, edges to which the node 300-2 writes data), and so the edge 304-1 also satisfies the fourth criterion.

In some examples, the subset of edges 304 selected at block 505 are those that satisfy all four of the criteria set out above. In the example of FIG. 6, the edge 304-1 is therefore selected at block 505, while the edge 304-2 is not selected. The edges 304 selected at block 505 are those that may have contributed to the deadlock, but increasing the capacity of each edge selected at block 505 may be an inefficient solution, as certain edges 304 may meet the criteria set out above but may not be the direct causes of the deadlock. Increasing the capacity of those edges 304 may therefore be unnecessary to resolve the deadlock, and unnecessary capacity increases, particularly when scaled across a graph including thousands of nodes, may lead to significantly less efficient operations at the apparatus 108.

At block 510, therefore, the device 120 is configured to select a portion of the graph defining the configuration data 124. The portion selected at block 510 can also be referred to as a dependency graph. The dependency graph includes nodes 300 that are blocked (that is, nodes 300 that cannot execute their currently active phases due to missing inputs and/or full outputs), and the edges 304 on which those nodes 300 are blocked. For example, if a node 300 has two output edges 304, and is blocked from writing to a first one of those edges but is able to write to the second output edge, the first output edge 304 is included in the dependency graph, while the second output edge 304 is omitted from the dependency graph. In the example of FIG. 6, both nodes 300-1 and 300-2 are blocked, and both are therefore selected at block 510. Further, the node 300-1 is blocked on the edge 304-1, and the node 300-2 is blocked on the edge 304-2. The nodes 300-1 and 300-2, as well as the edges 304-1 and 304-2, are therefore selected at block 310. In other words, the dependency graph may, but does not need to, include the entire graph defined by the configuration data 124.

At block 515, the device 120 is configured to traverse the dependency graph selected at block 510, searching for circular dependencies. More specifically, the device 120 is configured to select a buffer in the subset from block 505 as a starting point for the traversal. From the starting point, the device 120 is configured to identify the node 300 immediately downstream from the starting edge 304-1. Referring again to FIG. 6, the starting point “A” for the traverse is the edge 304-1, and the device 120 therefore proceeds to a point “B”, at the node 300-2, downstream of the edge 304-1. From any node 300 during the traverse, the device 120 is configured to determine whether the dependency graph includes any inbound edges 304 terminating at that node 300 that are blocking the current node 300. That determination, in the case of the node 300-2, is affirmative, because the edge 304-2 is blocking the node 300-2. The device 120 is also configured to determine whether there are any outbound edges 304 departing from the current node 300, that are preventing the current node 300 from outputting. That determination, in the example of FIG. 6, is negative, because the node 300-2 has no outbound edges.

The device 120, when either of the above determinations is affirmative, selects the relevant inbound or outbound edge as the next destination for the traverse. In the illustrated example, the device 120 therefore selects the edge 304-2 (point “C” along the traversal path in FIG. 6). The above process is then repeated, selecting the node 300 blocking the edge 304-2, and thus travelling to a point “D” corresponding to the node 300-1. At each segment of the path, the device 120 is configured to determine, at block 520, whether a loop (that is, a circular dependency) has been detected. The determination at block 520 includes a determination of whether the current element on the traversal path is an element that has been visited previously during the traversal. As will be apparent, the determination at block 520 is negative at the points A, B, C, and D. When the determination at block 520 is negative, the device 120 determines at block 525 whether the traverse is complete, e.g., whether there are no further blocked nodes or edges from the current point in the path. When the determination at block 525 is affirmative, performance of the method 500 ends. When the determination at block 525 is negative, the device 120 returns to block 515, to continue the traverse.

Referring again to FIG. 6, from the point D (that is, the node 300-1), the device 120 can determine that the node 300-1 is blocked on an outbound edge 304 (the edge 304-1). The device 120 can therefore advance to the edge 304-1, at the point “E”. As will be apparent from FIG. 6, the point E and the point A are the same element of the graph. Further, the point E and the point A correspond to the edge at which the traverse was started. In some examples, a loop may be identified that does not correspond to the starting point of the traverse. Such a loop does not necessarily indicate a deadlock, and does not result in an affirmative determination at block 520. In other words, the determination at block 520 is whether a loop has been identified that terminates at the starting point of the traverse. A circular dependency has therefore be identified, and the determination at block 520 is affirmative. The device 120 therefore advances to block 530, and selects a buffer to adjust. The buffer selected at block 530 is the starting point of the traverse initiated at block 515. In this case, the buffer selected at block 530 is the edge 304-1. The device 120 then proceeds to block 445.

As will be apparent, the process of blocks 515 to 530 can be repeated for any other edges selected at block 505. Further, in some examples, traversing the dependency graph may result in branches, e.g., if a given node 300 includes both an inbound edge blocking an upstream node 300, and an outbound edge 304 blocking a downstream node 300. In such examples, the device 120 can be configured to follow each branch until either an affirmative determination at block 525 or detection of a loop terminating at the starting point at block 520, and then return to the source of the branch and traverse the other branch.

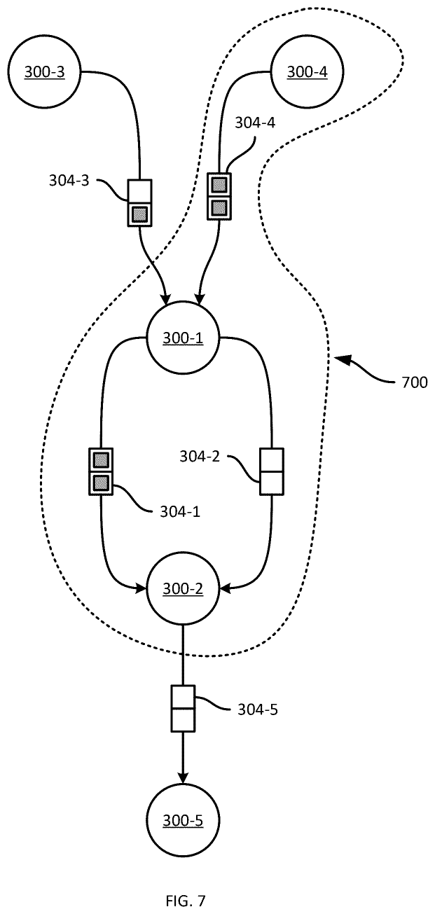

An example is shown in FIG. 7 with an expanded graph including nodes 300-3, 300-4, and 300-5, and edges 304-3, 304-4, and 304-5. The edge 304-4 is at capacity, is assumed (for the purpose of illustration) to be blocking output from the node 300-4, is inbound on a node with multiple inputs (the node 300-1), but the node 300-1 is blocked further downstream, and the edge 304-4 therefore does not satisfy every selection criterion. At block 505, only the edge 304-1 is therefore selected. At block 510, however, the dependency graph includes the portion 700 shown in FIG. 7, including the edge 304-4 and the node 300-4. During traversal of the dependency graph, the device 120 would traverse the loop shown in FIG. 6, but would not traverse the edge 304-4 or the node 300-4, as the edge 304-4 is not blocking the node 300-1.

The scope of the claims should not be limited by the embodiments set forth in the above examples, but should be given the broadest interpretation consistent with the description as a whole.

1. A method, comprising:
generating configuration data for a computing apparatus having a plurality of processing units with associated memory, the configuration data defining (i) a plurality of nodes corresponding to the processing units, and (ii) a plurality of buffers connecting respective pairs of the nodes, each buffer having a storage capacity;
executing a dataflow simulation using the configuration data;
in response to detecting a deadlock in the simulation, determining a candidate buffer among the buffers, the candidate buffer associated with the deadlock;
updating the configuration data to increase a storage capacity of the candidate buffer; and
deploying the updated configuration data to the computing apparatus.

2. The method of claim 1, wherein deploying the updated configuration data to the computing apparatus includes allocating portions of the memory according to the buffers defined in the updated configuration data.

3. The method of claim 1, wherein the configuration data includes a cyclo-static dataflow graph including a plurality of actor nodes corresponding to respective processing units, and a plurality of edges corresponding to respective buffers.

4. The method of claim 1, wherein the configuration data includes:
for each buffer, (i) a first endpoint node identifier and (ii) a second endpoint node identifier; and
for each node, a set of phase data corresponding to each buffer for which the node is an endpoint.

5. The method of claim 4, wherein executing the simulation includes:
determining whether any nodes can be activated; and
when the determination is affirmative, activating the identified nodes and updating contents associated with the buffers.

6. The method of claim 5, wherein detecting the deadlock includes:
determining that no nodes can be activated, and that the simulation is incomplete.

7. The method of claim 1, wherein determining the candidate buffer includes:
selecting a subset of the buffers;
selecting a portion of the configuration data corresponding to blocked nodes and the buffers blocking the blocked nodes; and
traversing the portion of the configuration data, beginning at one of the subset of buffers, to detect a circular dependency.

8. The method of claim 7, wherein selecting a given buffer for the subset of buffers is based on selection criteria including:
(i) the given buffer is at capacity;
(ii) the given buffer is blocking an upstream one of the nodes from outputting data;
(iii) the given buffer is connected as an input to a downstream one of the nodes with multiple inputs; and
(iv) the downstream node is not blocked by a further downstream buffer.

9. A computing device, comprising:
an interface connected with a computing apparatus having a plurality of processing units with associated memory; and
a processor configured to:
generate configuration data for the computing apparatus, the configuration data defining (i) a plurality of nodes corresponding to the processing units, and (ii) a plurality of buffers connecting respective pairs of the nodes, each buffer having a storage capacity;
execute a dataflow simulation using the configuration data;
in response to detecting a deadlock in the simulation, determine a candidate buffer among the buffers, the candidate buffer associated with the deadlock;
update the configuration data to increase a storage capacity of the candidate buffer; and
deploy the updated configuration data to the computing apparatus via the interface.

10. The computing device of claim 9, wherein the processor is configured to deploy the updated configuration data to the computing apparatus by allocating portions of the memory according to the buffers defined in the updated configuration data.

11. The computing device of claim 9, wherein the configuration data includes a cyclo-static dataflow graph including a plurality of actor nodes corresponding to respective processing units, and a plurality of edges corresponding to respective buffers.

12. The computing device of claim 9, wherein the configuration data includes:
for each buffer, (i) a first endpoint node identifier and (ii) a second endpoint node identifier; and
for each node, a set of phase data corresponding to each buffer for which the node is an endpoint.

13. The computing device of claim 12, wherein the processor is configured to execute the simulation by:
determining whether any nodes can be activated; and
when the determination is affirmative, activating the identified nodes and updating contents associated with the buffers.

14. The computing device of claim 13, wherein the processor is configured to detect the deadlock by:
determining that no nodes can be activated, and that the simulation is incomplete.

15. The computing device of claim 9, wherein the processor is configured to determine the candidate buffer by:
selecting a subset of the buffers;
selecting a portion of the configuration data corresponding to blocked nodes and the buffers blocking the blocked nodes; and
traversing the portion of the configuration data, beginning at one of the subset of buffers, to detect a circular dependency.

16. The computing device of claim 15, wherein the processor is configured to select a given buffer for the subset of buffers based on selection criteria including:
(i) the given buffer is at capacity;
(ii) the given buffer is blocking an upstream one of the nodes from outputting data;
(iii) the given buffer is connected as an input to a downstream one of the nodes with multiple inputs; and
(iv) the downstream node is not blocked by a further downstream buffer.
